(19) United States
(12) Patent Application Publication
(10) Pub. No.: US 2017/0021281 A1
(43) Pub. Date: Jan. 26, 2017

(54) METHODS AND SYSTEMS FOR PROVIDING CUSTOMIZED FANTASY SPORTS DATA

(71) Applicant: Steven Fanning, Centreville, VA (US)

(72) Inventor: Steven Fanning, Centreville, VA (US)

(21) Appl. No.: 15/217,954

(22) Filed: Jul. 22, 2016

Related U.S. Application Data
(60) Provisional application No. 62/195,293, filed on Jul. 22, 2015.

(51) Int. Cl. A63F 13/828; A63F 13/25; A63F 13/335; A63F 13/32; A63F 13/33

(52) U.S. Cl. CPC A63F 13/828; A63F 13/32; A63F 13/33; A63F 13/335; A63F 13/25

(57) ABSTRACT

There are provided methods and systems for providing customized fantasy sports data. For example, there is provided a system for creating a customized fantasy sport video feed. The system can include a processor and a memory including instructions that, when executed by the processor, cause the processor to perform certain operations. The operations can include receiving a first data set according to at least one of a plurality of rules. The first data set can include metadata associated with video clips of one or more sporting event. The operations can further include constructing a second data set based on at least one element of the first data set, the second data set including an ordered index associated with one or more of the video clips.

### CROSS-REFERENCE TO RELATED APPLICATIONS

The present disclosure claims the benefit of U.S. Provisional Patent Application No. 62/195,293, filed on Jul. 22, 2015, the disclosure of which is incorporated herein in its entirety by reference.

### BACKGROUND

The present disclosure relates to methods and systems for providing customized fantasy sports data. Without limitation, the disclosed methods and systems can be applied to many data types including video, statistical, and fantasy team data pertaining to one or more sporting events.

The background description provided herein is for the purpose of generally presenting the context of the disclosure. The work of the presently named inventor, to the extent it is described in this background section, as well as aspects of the description that may not otherwise qualify as prior art at the time of filing, are neither expressly nor impliedly admitted as prior art against the present disclosure.

Fantasy sports can be a significant revenue stream for sports content owners and/or licensees. However, while fantasy sport is becoming increasing popular, progress in the technological infrastructure for making fantasy sports possible has lagged significantly. For example, typical state-of-the-art fantasy providers allow fantasy sport players to compete based on statistical performance of players and according to set fantasy sports rules, but the fantasy players' experience has thus far been limited to simply comparing team or individual scores and league performance in a largely text-based web environment. Moreover, the current technological infrastructure for fantasy sports does not allow a fantasy sports player the ability to customize his or her fantasy sports experience. As such, there is a need for improved methods and systems for customizing and improving the experience of fantasy sports players.

The typical current experience of a fantasy player involved in a competition revolves around consuming statistics generated by real life sporting events that are then processed through a set of rules established for their league to generate scoring. A player has the opportunity to monitor their score of each individual on their fantasy team or the overall score of their fantasy team while real life sporting events are taking place or to check the scoring totals after their games have completed. Should a player desire a broader or more immersive experience than consumption of the points generated alone, there are few means to do so and those means are extremely limited in the experience they provide.

There are two main approaches for consuming additional media relevant to a fantasy game beyond the scoring alone. The first approach is for an owner to watch real life sporting events containing individuals relevant to their fantasy team. Unfortunately, players typically have relevant individuals playing in a large number of real life sporting events that could take tens of hours to watch for any given matchup making this an undesirable or untenable approach for many players. In this approach a player would also be presented with large amounts of video content that is irrelevant to their fantasy game during activity of individuals not on the player's team. The second approach that is the current state-of-the-art for consuming only video footage specifically relevant to a fantasy player's team is generated by the website in which the league is managed. This approach presents a line graph of the player's score over time with clickable bubbles along said line. Once clicked, each bubble will display a noteworthy portion of the sporting event or an individual play. The clickable bubbles, being the state-of-the-art, are merely a means to provide access to highlights of sporting events relevant to a player's team.

One major drawback of this is that the highlights provided are those deemed important enough by a third party to warrant inclusion in the system. The selection of individual highlights presented to the player are not necessarily what the fantasy player would have decided they would like to have access to. Another major drawback of this approach is that each highlight must be manually chosen by the player and clicked upon. This makes the state-of-the-art approach only marginally more convenient than manually searching the internet for individual video highlights. These drawbacks combined with a desire for an immersive fantasy entertainment experience accessible on computers, mobile devices, television sets, etc. establishes a need for a truly customizable and automated means of video, statistical, and fantasy team data organization and presentation.

### SUMMARY

In one embodiment, there is provided a system for creating a fantasy sport video feed. The system can include a processor and a memory including instructions that, when executed by the processor, cause the processor to perform certain operations. The operations can include receiving a first data set according to at least one of a plurality of rules. The first data set can include metadata associated with video clips of one or more sporting event. The operations can further include constructing a second data set based on at least one element of the first data set, the second data set including an ordered index associated with one or more of the video clips.

In another embodiment, there is provided a method for creating a fantasy sport video. The method can include receiving, by a processor, a first data set according to at least one of a plurality of rules. The first data set can include metadata associated with video clips of one or more sporting event. The method can further include constructing, by the processor, a second data set based on at least one element of the first data set, the second data set including an ordered index associated with one or more of the video clips.

In yet another embodiment, there is provided a non-transitory computer-readable medium including instructions that, when executed by a processor, cause the processor to perform certain operations. The operations can include receiving a first data set according to at least one of a plurality of rules. The first data set can include metadata associated with video clips of one or more sporting event. The operations can further include constructing a second data set based on at least one element of the first data set, the second data set including an ordered index associated with one or more of the video clips.

### BRIEF DESCRIPTION OF THE DRAWINGS

FIG. 1 illustrates a system according to various aspects described herein.

FIG. 2 illustrates a component of a graphical user interface according to various aspects described herein.

FIG. 3 illustrates a component of a graphical user interface according to various aspects described herein.

FIG. 4A illustrates a component of a graphical user interface according to various aspects described herein.

FIG. 4B illustrates a component of a graphical user interface according to various aspects described herein.

FIG. 5 illustrates a flow chart of a method according to various aspects described herein.

FIG. 6 illustrates a system according to various aspects described herein.

### DETAILED DESCRIPTION

Embodiments will be described below in more detail with reference to the accompanying drawings. The following detailed descriptions are provided to assist the reader in gaining a comprehensive understanding of the methods, apparatuses, and/or systems described herein as well as modifications thereof. Accordingly, various modifications and equivalents of the methods, apparatuses, and/or systems described herein will be apparent to those of ordinary skill in the art. Descriptions of well-known functions and constructions may be omitted for increased clarity and conciseness.

Furthermore, the terms used herein are intended to describe embodiments only and shall by no means be restrictive. Unless clearly used otherwise, expressions in a singular form include a meaning of plural form. An expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

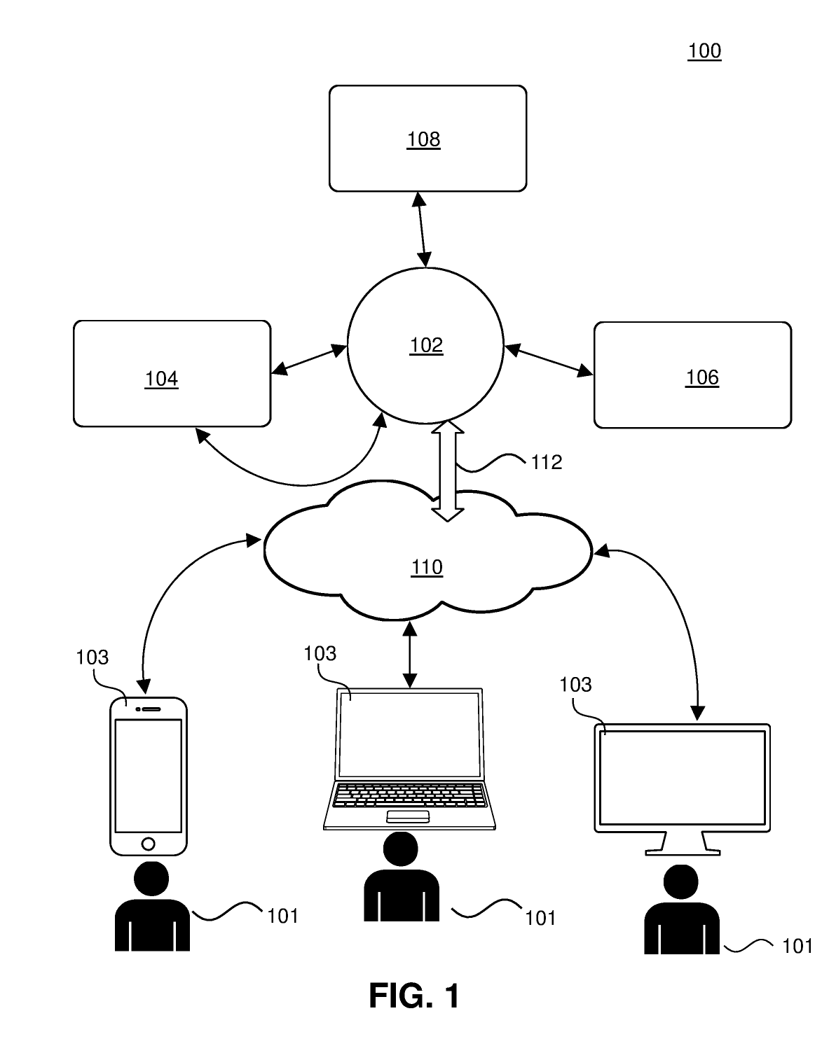

FIG. 1 illustrates a system 100 according to an embodiment. The system 100 can include a plurality of computing devices (102, 104, 106, and 108) that are communicatively coupled (as indicated by the arrows) to provide functionalities relating to fantasy sports data customization and management to a plurality of users 101. The system 100 can be coupled to a plurality of user devices 103 via a network 110 through a communication link 112.

The plurality of user devices 103 can include, without limitation, mobile phones, desktop, laptop, or tablet devices, as well as smart TVs and the like. The network 110 can be, without limitation, either a Wi-Fi network, a local area network, the Internet, or any communications network that can provide connectivity between the plurality of user devices 103 and the system 100. The communications link 112 can be a wireless or a wired communications link.

One of skill in the art will readily recognize that network configurations other than the one shown in FIG. 1 can be used, without departing from the scope of this disclosure. Moreover, while only few components are shown and only three users, it should be readily appreciated that the system 100 can be implemented to accommodate more than three users, and that additional components can be included to provide the functionalities of the system 100 described below to more than three users.

In the system 100, the computing device 102 can be a server including a processor configured to perform a plurality of operations relating to fantasy sports data management. The processor can be configured with instructions, which when executed by the processor, cause the processor to perform the aforementioned plurality of operations. These operations can be performed based on input data received from the other computing devices shown in FIG. 1. For example, the processor of the computing device 102 can receive video metadata and fantasy scoring data from a fantasy and video database (not shown). This database can be retrieved by the processor from the computing device 106, for example.

The fantasy scoring data can be in the form of a data structure that includes scores associated with actual players of a fantasy team owner. The data structure can be a relational database in which entries are associated with video metadata. In one exemplary use case, the metadata can be an entry that associates a play from a specified American football (hereinafter “NFL®”) player (i.e. the actual player) with a file name (or any other identifier) of the video footage associated with the play; the data structure can then include an entry relating the described metadata with the owner of the fantasy team. Association with the owner can be performed by the processor of the computing device 106 based on a database including data relating fantasy team owners with NFL® players that are in their fantasy teams.

The computing device 108 can be, for example, a server that includes a processor configured to provide information to the computing device 106. This information can include a plurality of rules that govern the fantasy sport, which, in the exemplary use case described above would be fantasy football. These rules can be based on statistical data relating to the performance of the athletes in the NFL®. In other words, based on an athlete's performance in a play, the computing device 102, once the rules are fetched from the computing device 108, can assign a score to a given athlete for a player. For example, if a wide receiver named “John Doe” from an NFL® team called “TEAM A” runs 25 yards in a given game at a particular date and time, the computing device 102 can assign 2.5 points (i.e. a fantasy score) to John Doe based on the rules retrieved from the computing device 108. As such, any fantasy team owner that has John Doe on their team, and has the same scoring structure, is credited two and a half points as their fantasy score.

One of skill in the art will readily recognize that the fantasy sports rule can be changed or programmed into the computing device 108 by a fantasy team sport service provider or individual league. The particular configuration of these rules can change at any time by any party and does not affect the teachings presented herein. Furthermore, it should be noted that the rules can be retrieved from the computing device 108 by the computer 102, and that the rules can be in the form of a file, a database, or any other format that associates NFL® athletes' names with a particular scoring system, as well as with the date and time of games in which the athletes played.

Therefore, considering the computing devices 102, 106, and 108, the system 100 is configured to provide fantasy sports data composite information that can include NFL® athletes name, fantasy score (for a team, individual, or play), video metadata, and fantasy team owner. The system 100 can further use the composite information along with contextual information to provide the plurality of users 101 a customized fantasy sport experience.

For example, the computing device 104 can include a processor that is a configured to receive contextual information that includes user settings. For example, a user of the plurality of users 101 can transmit contextual information to the system 100, which may be processed by the computing device 104. The contextual information can include a series of instructions for the system 100 to provide the user with specific fantasy information. For example, the contextual information can include a request for (a video file or playback on the users screen) of one or more plays associated with an NFL® athlete. The request can further include a query for the score associated with that athlete, and it can also include a query for score and status an opponent's fantasy team (i.e. of a fantasy team belonging to another one of the plurality of users 101).

In one exemplary use case, a first user can request the system 100 to provide a continuous video playback of all plays related to the NFL® athletes on the first user's fantasy team. The computing device 104 then receives the contextual information in the form of a request that includes the user's name (or team's name, or any other identifier), the settings, i.e. the dates and times for which the video is requested, and score information for the user's team for the given date and times, as well as similar information pertaining to another user's team.

Once the computing device 104 receives the contextual information, together with the computing devices 102, 106, and 108, the systems can provide the user with the requested information by providing data structures and/or video playback that includes the requested contextual information. For example, the user can be provided with a video playback that includes one or more sets of frames, each set corresponding to video clips of the plays of the NFL® athletes on the user's team. The frames can include video and audio, and other data known in the art. The frames can be indexed in time, i.e. they can be synchronous, or they can be asynchronous. The video playback can be made of one or more video clips corresponding to the user's contextual information, thus providing a customized fantasy sport video experience. This experience would constitute what the user has defined as their preferred way of consuming their fantasy match. The video playback can be executed directly on the user's device, through a graphical interface configured for input and output to the system 100, as shall be described in greater detail below.

Generally, the system 100 can include a memory and a processor configured to execute instructions in the memory to perform certain operations relating to the various computing devices described above. In other words, the system 100 can be implemented with one computing device that performs the operations described above with respect the computing devices 102, 104, 106, and 108. The operations can include receiving a first data set according to at least one of a plurality of rules, the first data set including metadata associated with video clips of one or more sporting event and/or contextual information from a user. The operations can further include constructing a second data set based on at least one element of the first data set. The second data set can include an ordered index associated with one or more of the video clips. The ordered index can be an index of frames or of sets of frames. The ordered index can be used to construct a video feed that is customized to the user's contextual information.

As described in the exemplary use case, the rules can be that of fantasy sport like those associated with the NFL®, but the applicability of the system 100 also extends to hockey, baseball, soccer, or basketball fantasy sports for example. Generally, the system 100 can be configured to provide customized for any fantasy sport application.

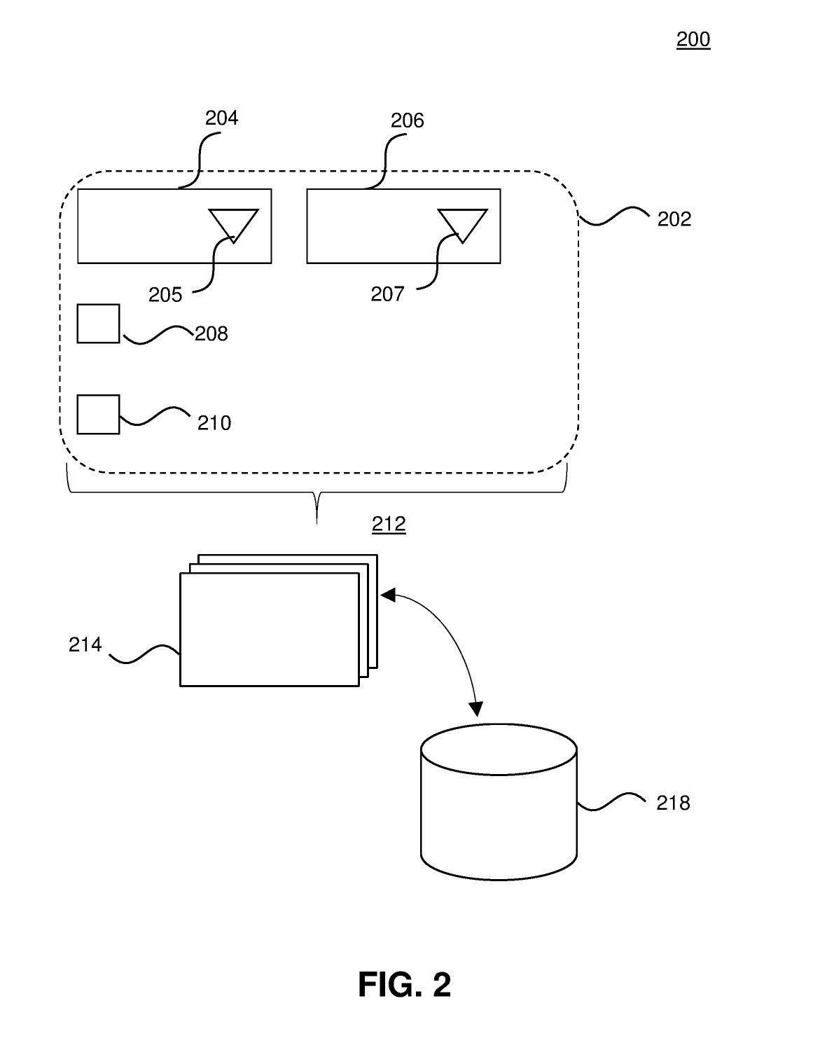

FIGS. 2, 3, 4A, and 4B illustrate several embodiments of graphical user interfaces through which the plurality of users 101 can, via the plurality of user devices 103, input and output information to and from the system 100. An input can be construed as providing the contextual information to the system 100 and an output can be construed as receiving the requested contextual information.

For example, with respect to FIG. 2, one embodiment can provide a graphical user interface (GUI) 200 that includes a component 202. The component 202 can be a front-end feature of the GUI 200, and the GUI 200 can also include a back-end feature 212 (below the horizontal bracket), as is known in the art. Changes effected in the component 202 on the front-end can be translated to the back-end feature 212 in the form of instructions 214 that can be stored in a state database 218. When communicating, e.g. when transmitting contextual information inputted in the front-end component 202, a device executing the GUI 200 transmits the instructions 214 that represent the state of the GUI 200, as changed in the component 202. The instructions can be transmitted on the fly (i.e. as soon as the component 202 is altered), or they can be stored in the state database 218, retrieved, and then transmitted.

The component 202 can include a plurality of fields 204, 206, 208, and 210. Some of these fields can be pull-down menus (such as fields 204 and 206) which can be altered using a pull-down button (e.g. buttons 205 or 207). Other fields can be check boxes or radio buttons (like fields 208 and 210).

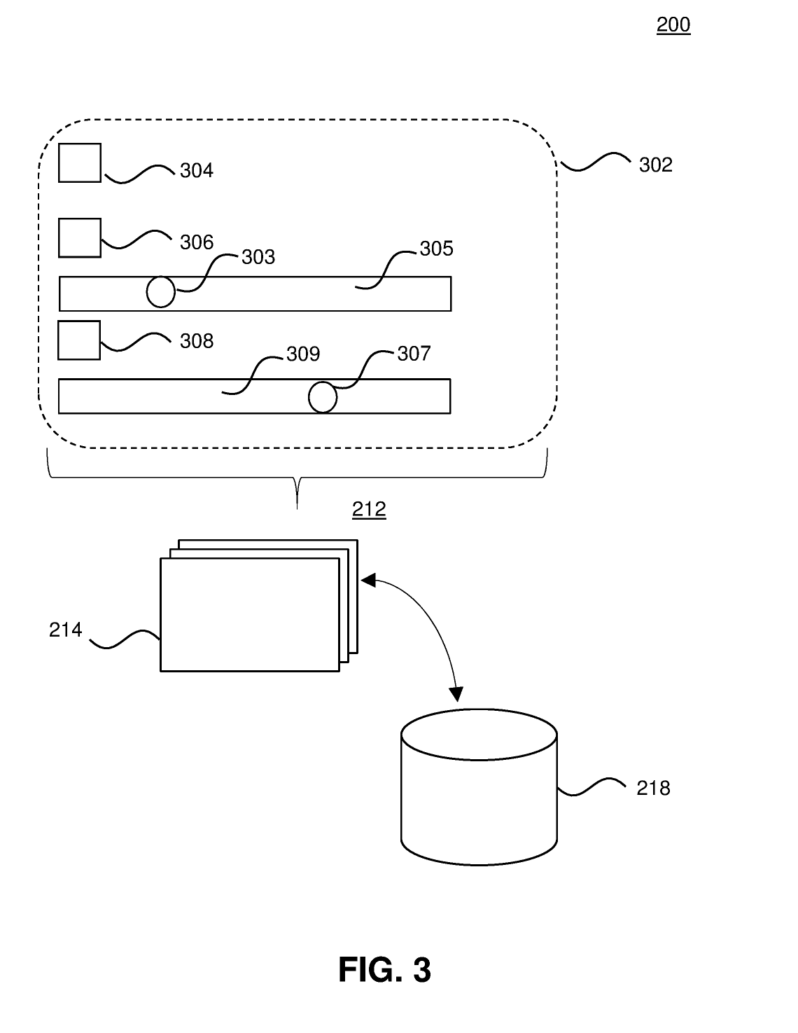

The fields 204 and 206 can be global settings. Using the NFL® as an example, these fields can provide a means for selecting the year and the week of interest. Similarly, the fields 208 and 210 can be selection boxes that allow for customizability of viewing options. Generally, the component 202 can be a means for inputting global settings, whereas FIG. 3, on the other hand, shows a component 302 of the GUI 200 where particular (or local) settings can be applied.

The component 302 can include fields 304, 306, and 308, which, respectively, can for example let a user select whether to play video playback relating to every scoring play, play a video playback relating to all plays above an adjustable point threshold, or play a video playback relating to all plays above an adjustable time duration threshold. The adjustable point threshold can be adjusted via a rolling component 303 of the field 305, and the adjustable time duration threshold can be adjusted via a rolling component 307 of the field 307. As in the case of the component 302, the settings imparted in the component 302 can be translated to the back-end feature 212 and transformed into the instructions 214, which can be stored in the database 218.

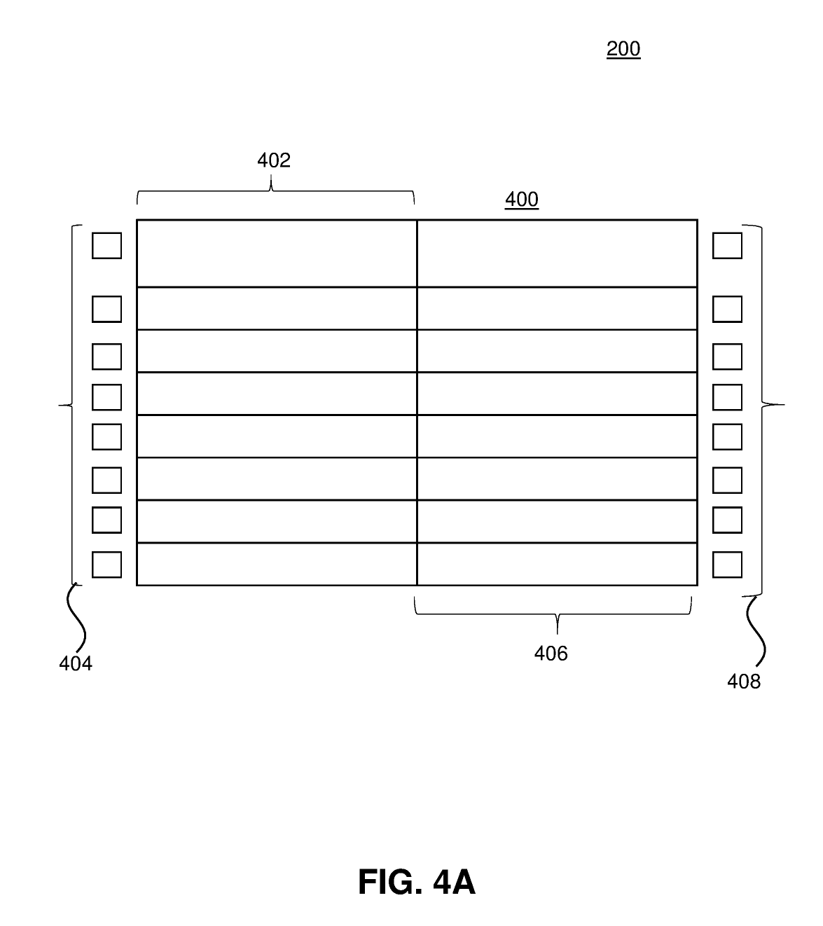

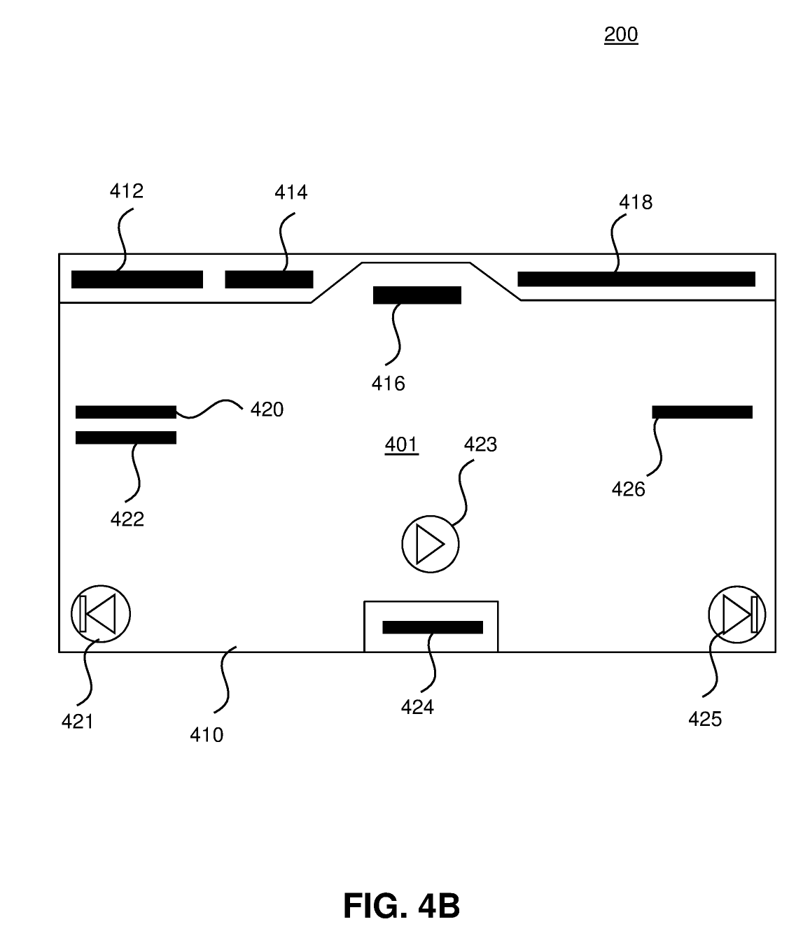

FIGS. 4A and 4B show different components of the GUI 200 that can be used to present the requested contextual information to a user. For example, with respect to FIG. 4A, for a request for a user's own fantasy team performance and an opponent's fantasy team performance, the user can be presented a table 400 that displays the user's fantasy team performance data in a column 402 and the opponent's fantasy team performance data in a column 406. The user can then see his performance alongside the opponent's team. Furthermore, the user can generate further contextualized output data through either one of selection's boxes 404 or 408, where each box on a given side can correspond to an athlete on either the user's team or the opponents.

FIG. 4B illustrates an example playback component 401 of the GUI 200 which can be configured to play a video playback that is constructed as explained above, based on the user's contextual information. The video playback component 401 can include a plurality of fields (412, 414, 416, 418, 420, 422, 424, and 426). These fields can be configured to display information (such as video metadata, score, etc . . . ) or any other information that pertains to the video that is being played in a central region of the video playback component 401. Additionally, information can be presented and removed from the screen as the video progresses though the sequence of videos, such that the information being displayed during any individual clip would be directly tied to the action taking place on the screen. This could include points accumulated from the actions of the individual being displayed in the current play, total aggregate score up to the moment in the day the play took place, and so forth. The video playback can be stopped, paused, rewound, or moved forward using buttons 423, 421, and 425.

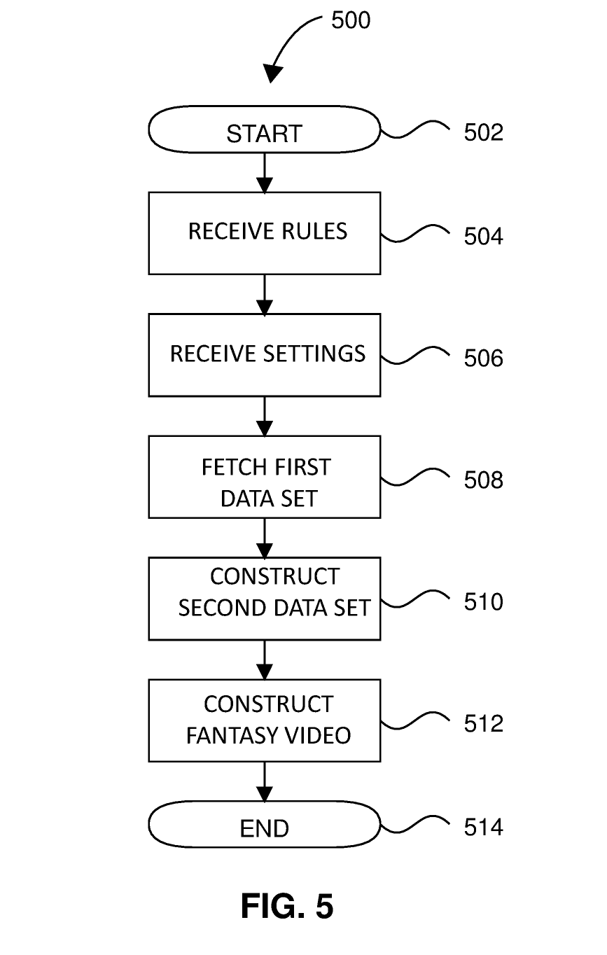

Having set forth various embodiments that can provide customized fantasy sport data and experience, a method 500 consistent with their operation is now described with respect to FIG. 5. The method 500 can begin at block 502, and it can be executed by the system 100, which can include at least one processor like the processor 602 described hereinafter. The method 500 can include creating a fantasy sport video based on contextual user information. The method 500 can include receiving, by a processor, a first data set according to at least one of a plurality of rules and a plurality of user settings (blocks 504, 506, and 508). The first data set can include metadata associated with video clips of one or more sporting event. The method 500 can further include constructing, by the processor, a second data set based on at least one element of the first data set (block 510). The second data set can include an ordered index associated with one or more of the video clips.

The plurality of rules can be that of a fantasy sport like American football. The method 500 can include creating the fantasy sport video based on the ordered index (block 512). The fantasy sport video can include a plurality of synchronous video frames of the one or more sporting event. In the alternative, or in addition, the fantasy sport video can include a plurality of asynchronous video frames of the one or more sporting event. The method 500 can end at block 514.

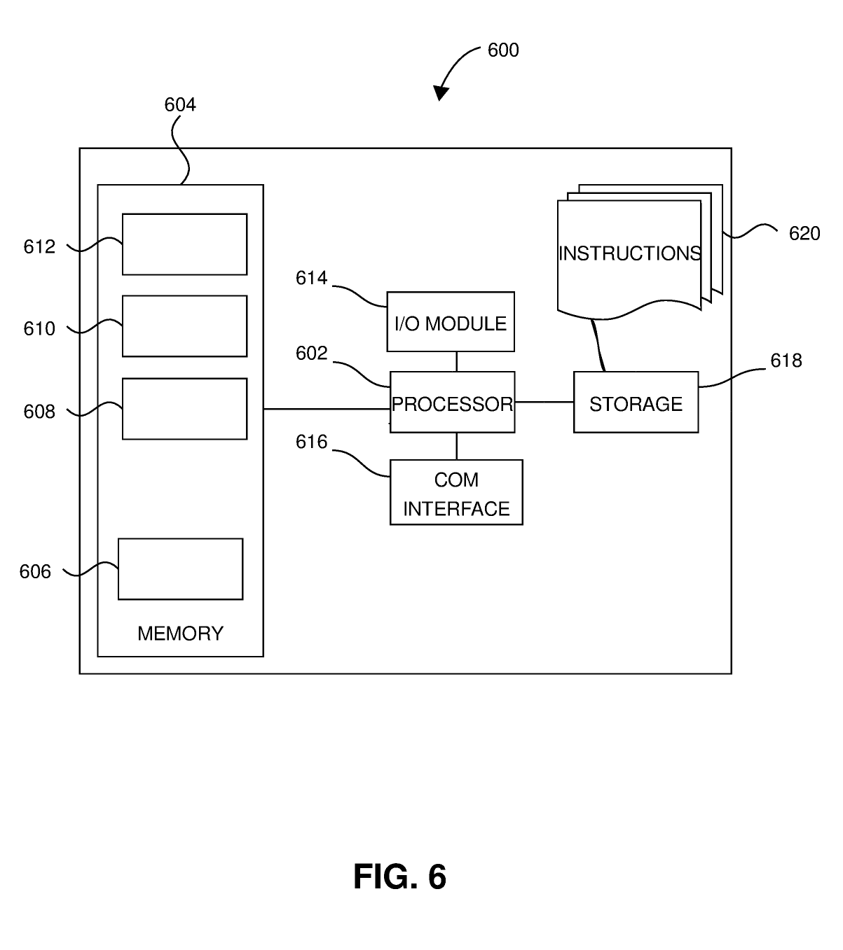

FIG. 6 shows a block diagram of a system 600, which can include a processor 602 that has a specific structure. The system 600 can be configured to performed all the operations, methods, and steps throughout this disclosure. The specific structure of the processor 602 can be imparted to the processor 602 by instructions stored in a memory 604 included therein and/or by instructions 620 that can be fetched from a storage medium 618. The storage medium 618 may be co-located with the system 600 as shown, or it may be located elsewhere and be communicatively coupled to system 600.

The system 600 can be a stand-alone programmable system, or it can be a programmable module located in a much larger system. For example, system 600 can be part of such as a fantasy sports server. The system 600 may include one or more hardware and/or software components configured to fetch, decode, execute, store, analyze, distribute, evaluate, and/or categorize information. Furthermore, the system 600 can include an input/output (I/O) module 614 that can be configured to interface with a plurality of computers, servers, and the like, via a network or via a cloud for example.

The processor 602 may include one or more processing devices or cores (not shown). In some embodiments, the processor 602 may be a plurality of processors, each having either one or more cores. The processor 602 can be configured to execute instructions fetched from the memory 604, i.e. from one of memory blocks 612, 610, 608, or memory block 606, or the instructions may be fetched from the storage medium 618, or from a remote device connected to the system 600 via a communication interface 616.

Furthermore, without loss of generality, the storage medium 618 and/or memory 604 may include a volatile or non-volatile, magnetic, semiconductor, tape, optical, removable, non-removable, read-only, random-access, or any type of non-transitory computer-readable computer medium. The storage medium 618 and/or the memory 604 may include programs and/or other information that may be used by the processor 602. Furthermore, the storage medium 618 may be configured to log data processed, recorded, or collected during the operation of system 600. The data may be time-stamped, location-stamped, cataloged, indexed, or organized in a variety of ways consistent with data storage practice.

In one embodiment, for example, the memory block 606 may include instructions that, when executed by the processor 602, cause processor 602 to perform certain operations. The operations can include receiving a first data set according to at least one of a plurality of rules. The first data set can include metadata associated with video clips of one or more sporting event. The operations can further include constructing a second data set based on at least one element of the first data set, the second data set including an ordered index associated with one or more of the video clips.

The plurality of rules can include rules of a fantasy sport, such as, without limitation, American football. The operations can further include creating the fantasy sport video based on the ordered index. The operations can further include executing a graphical user interface configured for playing the fantasy sport video. The graphical user interface can include one or more components or all of the components shown in FIG. 2-4. The fantasy sport video can include a plurality of synchronous video frames of the one or more sporting event. In the alternative, the fantasy sport video can a plurality of asynchronous video frames of the one or more sporting event.

The operations can further include retrieving one or more user settings and the plurality of rules from a database communicatively coupled to the processor. The operations can further include fetching the first data set from the database according to the user settings and the plurality of rules. The operations can further include storing the one or more user settings in the database prior to their retrieval by the processor.

Having described several exemplary embodiments, several advantages conferred by these embodiments and, in general, by the teachings set forth herein are discussed below, without limitation to the example use cases described. This disclosure allows fantasy team owners (the person managing a fantasy team) to watch a video of their fantasy matchup, as if it were a real sports game, for the first time.

The exemplary system described above revolutionizes the fantasy gaming experience by bringing the excitement of viewing sports competitions to the fantasy arena. Until now, the week-to-week/day-to-day fantasy owner's matchup experience has been largely based upon consumption of text based matchup scoring to monitor their matchups. As for video consumption, fantasy owners have only had access to:

1) Highlights deemed ‘major’ by the professional league associated with their fantasy game or media outlets.

2) Live broadcast games in which their fantasy game players participate, which in many cases amounts to many more hours of content than any typical owner is able to consume.

The premise of this disclosure is that an owner now has the ability to watch a video of their fantasy matchup that is dynamically created from a database of video content housed by a content provider. The dynamic nature of the video stems from clips of individual plays associated with players on the owner's team being pulled and assembled chronologically according to the order in which they occurred in real time. Additionally, a series of customizability settings (contextual information) are implemented based on factors the owner deems important to their video watching experience.

This disclosure is applicable to any sport or non-sport based fantasy game for which there is video footage of the events upon which scoring is based. This includes, but is not limited to, the National Football League (NFL)®, Major League Baseball (MLB)®, National Hockey League (NHL)®, National Basketball Association (NBA)®, National Association for Stock Car Auto Racing (NASCAR)®, Professional Golf Association (PGA)®, etc. as well as other sports such as cricket, rugby, Australian rules football, wrestling, surfing, formula 1 racing, mixed martial arts, or boxing.

In one embodiment, an owner interfaces with a website that draws upon a database of clips that are able to be strung together, at the time of the owner's request, to create an owner's ‘custom fantasy matchup video’. Setting up this service as a dynamically customizable feature allows the factors most important to an individual owner to influence the final video output they consume. An owner can consume their custom fantasy matchup video at varying lengths based on criteria that are customized via slider bars and check boxes associated with the video viewing box. Customizability criteria, of which only a single option can be selected, includes (but is not limited to):
Option 1) Watch every scoring play
Option 2) Watch every scoring play above a certain point threshold

(With this option, the plays pulled by the system are chosen dynamically based on the point threshold chosen in conjunction with the league scoring settings and logged fantasy stats associated with the individual plays. The system knows the scoring settings, as the owner is logged into their account).
Option 3) Watch the highlights of your matchup in a video under (2, 5, 10, 15, 20 minutes etc.)

(With this option, the highest point value plays pulled by the system are chosen dynamically based on the total time of the final video desired in conjunction with the league scoring settings and logged fantasy stats associated with the individual plays. The system knows the scoring settings, as the owner is logged into their account).

Additionally, there are Global Settings that can be selected independently, if desired, from the Viewing Options above, such as:
Global Setting 1: Select the matchup to watch.

(Using the NFL as an example this equates to selecting the year and week. The ability to select the year requires the owner to have been a member of the website for more than the current year, as their fantasy data from prior seasons would need to be accessible.)
Global Setting 2: Watch only ‘my’ team's plays
Global Setting 3: Watch plays only from select players

(If selected, then selection boxes appear next to the individual players on a fantasy scoring table.)

As a custom fantasy matchup video is displayed, there are several pieces of information that can be displayed in conjunction with the video itself to provide a more custom and immersive experience. For example, an overlay of the score of each player is shown on the screen at all times so an owner can see what the score was during the real time moment of the play they are watching. Additionally, individual player scoring is shown, if desired, in conjunction with the overall points scored by each team in the current play. Contextual information such as the real time day/time that the current play occurred is also displayable if desired. Several layouts for video consumption could also be made available to the team owner (if desired by the content server), including but not limited to:

1) A side by side view of the owner's team plays as they occurred ‘in real time’ next to those of his opponent.

2) A single video stream that bounces back and forth between scoring plays of the owner and those of their opponent. The chosen plays all run back to back in the order in which they occurred in ‘real time’. During a single play, scoring can take place by multiple players on either team, but the clip would only be shown once, and overlay each scoring player's points from the play in the single clip.

Additionally, the video should be displayed with a common side-by side scoring table elsewhere on the webpage, which are customary in most fantasy game scoring displays. However, this table should be tied to the custom fantasy matchup video and show the score of each individual player tallied up through the current play being displayed in the video.

A content provider can offer custom fantasy matchup videos with several different availability windows including, but not limited to, the following:

### 1) After Sets of Games

For example, with the NFL, an owner can watch their custom fantasy matchup video following the Sunday 1 PM games, the Sunday 4 PM games, the Sunday night game, and the Monday night game. Making these videos available after sets of games results in the desirable experience of a seamless video sequence up to that point of their matchup.

### 2) Through the Current Moment

If a content provider opted to log and tag fantasy and video data close to real-time, then fantasy owners are able to view a custom fantasy matchup video of all scoring action up to that point in the matchup.

### 3) Live Feed

This approach results in a user-experience in instituting a near real-time implementation in which a ‘live-feed’ of a fantasy matchup is conveyed to the owner. There would inevitably be large spans of time without footage, when no scoring is taking place. These time spans could be filled with several feeds of content not limited to: non-fantasy relevant game action such as live footage from a player's favorite NFL® team, footage from a set of other individual players, footage from another team's relevant players, or a specific channel like NFL REDZONE®.

The custom fantasy matchup video is made possible through a system of tagging video footage of ‘plays’ from the source sporting or non-sporting event with metadata. This is implementable in several ways, with the most reasonable two being:

1) Slicing broadcast feeds into a series of individual video files that have associated searchable metadata that can be referenced to allow for the appropriate clips to be pulled and strung together in a custom fantasy matchup video based on customizability criteria

2) Setting key frames in each full event video feed of the various broadcast games, such that each section between key frames is an individual play that is then associated with searchable metadata about the play. This metadata can then be referenced to allow for the appropriate plays to be pulled and strung together in a custom fantasy matchup video request.

The metadata referenced above includes a variety of data relevant to the fantasy game being played. Using professional American football as an example this would then include the following (but not limited to):

### 1) Time of Play Start

a. This allows for the clips to be organized chronologically in the final full matchup video feeds

b. This allows for the day/time the play occurred in real time to be displayed on the screen

### 2) Length of Play

a. For determining inclusion of plays based on customizability criteria

### 3) Player Names Participating in the Play

a. This is used to source the correct clips containing players from either the owner's team or their opponent.

### 4) Example Normal Factors Tied to the Individual (or Grouped) Fantasy Players Logged Above

a. Yards (rushing, receiving, passing)

b. Touchdowns (rushing/receiving, passing)

c. Catches

d. Fumbles

e. Interceptions

f. 2 pt. Conversions

g. Field Goals

The metadata and video footage are ideally linked to the fantasy data that is already being cataloged in real time during the live sporting/non-sporting events. This method associates the new data needed for the custom fantasy matchup videos with that already being logged for fantasy scoring purposes in a single database. This has the benefit of having all fantasy relevant data entered only a single time for each data value, thus saving time and avoiding data inconsistencies that may stem from entering data in multiple locations. Much of the data for fantasy scoring already being logged by fantasy sites is also relevant for this disclosure.

The process of generating a fantasy matchup video can be set up to occur in several ways, but plays out as follows. A fantasy owner is logged into their account on a fantasy website, which has now implemented a custom fantasy matchup video feature to go along with their existing fantasy system. The owner requests a custom fantasy matchup video with a series of customizability constraints as detailed above. These criteria are communicated to content provider systems, along with the relevant player names on both their teams and their opponents' teams in addition to the scoring system rules for the owner's league (all of which is readily housed within the user's account information). The customization criteria, team roster information, and league scoring rules are all then processed through a series of coded algorithms against the various fantasy data and video metadata housed on the content provider's system. The algorithms then sting together and serve up the appropriate series of play clips in chronological order as a seamless custom fantasy matchup video to the fantasy owner on their video consumption device (computer, television, mobile device, etc.). An informational overlay, as described above, is displayed over the video to provide relevant information giving extra context to the custom fantasy matchup video at each given moment, thus improving the overall user experience.

Although the drawings describe operations in a specific order and/or show specific arrangements of components and are described in the context of fantasy American football, one should not interpret that such specific order and/or arrangements limit the scope of the present disclosure, or that all the operations performed and the components disclosed are needed to obtain a desired result.

What is claimed is:

1. A system for creating a fantasy sport video feed, the system comprising:
a processor;
a memory including instructions that, when executed by the processor, cause the processor to perform operations comprising:
receiving a first data set according to at least one of a plurality of rules, the first data set including metadata associated with video clips of one or more sporting event; and
constructing a second data set based on at least one element of the first data set, the second data set including an ordered index associated with one or more of the video clips.

2. The system of claim 1, wherein the plurality of rules include rules of a fantasy sport.

3. The system of claim 2, wherein the fantasy sport is American Football.

4. The system of claim 1, wherein the operations further include creating the fantasy sport video based on the ordered index.

5. The system of claim 4, wherein the operations further comprise executing a graphical user interface configured for playing the fantasy sport video.

6. The system of claim 4, wherein the fantasy sport video includes a plurality of synchronous video frames of the one or more sporting event.

7. The system of claim 4, wherein the fantasy sport video includes a plurality of asynchronous video frames of the one or more sporting event.

8. The system of claim 1, wherein the operations further include retrieving one or more user settings and the plurality of rules from a database communicatively coupled to the processor.

9. The system of claim 8, wherein the operations further include fetching the first data set from the database according to the user settings and the plurality of rules.

10. The system of claim 1, wherein the operations further include storing the one or more user settings in the database prior to their retrieval.

11. A method for creating a fantasy sport video, the method comprising:
receiving, by a processor, a first data set according to at least one of a plurality of rules, the first data set including metadata associated with video clips of one or more sporting event; and
constructing, by the processor, a second data set based on at least one element of the first data set, the second data set including an ordered index associated with one or more of the video clips.

12. The method of claim 11, wherein the plurality of rules include rules of a fantasy sport.

13. The method of claim 12, wherein the fantasy sport is American Football.

14. The method of claim 11, further comprising creating the fantasy sport video based on the ordered index.

15. The method of claim 14, wherein the fantasy sport video includes a plurality of synchronous video frames of the one or more sporting event.

16. The method of claim 14, wherein the fantasy sport video includes a plurality of asynchronous video frames of the one or more sporting event.

17. A non-transitory computer-readable medium for creating a fantasy sport video feed, the computer-readable medium comprising instructions that, when executed by a processor, cause the processor to perform operations comprising:
receiving a first data set according to at least one of a plurality of rules, the first data set including metadata associated with video clips of one or more sporting event; and
constructing a second data set based on at least one element of the first data set, the second data set including an ordered index associated with one or more of the video clips.

18. The non-transitory computer-readable medium of claim 17, wherein the plurality of rules include rules of a fantasy sport.

19. The non-transitory computer-readable medium of claim 18, wherein the fantasy sport is American Football.

20. The non-transitory computer-readable medium of claim 17, wherein the operations further include creating the fantasy sport video based on the ordered index.
